(19) United States
(12) Patent Application Publication
(10) Pub. No.: US 2026/0057860 A1
(43) Pub. Date: Feb. 26, 2026

(54) KICK PEDAL SPRING TENSION ADJUSTING DEVICE AND DRUM SET KICK PEDAL MECHANISM USING THE SAME

(71) Applicant: K.H.S. MUSICAL INSTRUMENT CO., LTD., New Taipei City (TW)

(72) Inventor: Chun-Hsing CHEN, New Taipei City (TW)

(73) Assignee: K.H.S. MUSICAL INSTRUMENT CO., LTD., New Taipei City (TW)

(21) Appl. No.: 18/814,309

(22) Filed: Aug. 23, 2024

(51) Int. Cl. G10D 13/11

(52) U.S. Cl. CPC G10D 13/11

(57) ABSTRACT

A spring tension adjusting device is assembled to a drum set kick pedal mechanism for striking a drum top head. The spring tension adjusting device includes a locating support connected to a rotational shaft; an adjustment assembly movably provided on the locating support and including a screw shaft and a spring locating section; a spring assembly connected at an end to the rotational shaft and at another end to the spring locating section; and an operating handle having a shank connected to between the screw shaft and an operating section of the operating handle. When the operating handle is rotated, the shank is brought to rotate synchronously, and the spring locating section moves along an axial direction of the shank in a linear motion. Meanwhile, the spring assembly is changed from an original length to an adjusted length to adjust a tension of the spring assembly.

### FIELD OF THE INVENTION

The present invention relates to a kick pedal spring tension adjusting device, and more particularly, to a kick pedal spring tension adjusting device assembled to a drum set kick pedal mechanism, such that the kick pedal spring tension adjusting device can not only drive the kick pedal mechanism to strike a drum top head, but also adjust a spring tension of the kick pedal quickly via an operating handle.

### BACKGROUND OF THE INVENTION

A drum set is a collection of many important percussion instruments in an orchestra. Most drum sets include a bass drum, a snare drum, a tom drum, a floor drum, a bass drum pedal, and a China cymbal. The China cymbal can be further divided into crash cymbal, ride cymbal, trash cymbal, and splash cymbal.

In the drum set, a kick pedal mechanism is used to control a beater to strike a drum top head of a bass drum. When a musical repertoire includes musical compositions of different genres to be performed continuously, the drum top head has to be struck with different striking force to produce different timbres.

The beater swing is controllable by adjusting the user's kicking on the pedal, and different beater swings can produce different striking strength. To ensure that a consistent timbre is produced when using the beater to strike the drum top head, it is necessary to strike the beater with the same strength.

There is an elastic component assembled to between the kick pedal and the beater, and the elastic component is extendable to exert different elastic tensions, which in turn controls the beater swing. Therefore, a consistent swing timbre can be produced by kicking the kick pedal.

Most of the kick pedal mechanisms include an adjustment member connected to a spring assembly, so that the user can adjust the spring assembly to a desired elastic tension through turning the adjustment member. Conventionally, the adjustment member is normally provided at a bottom of the kick pedal mechanism and located close to the ground. The user has to stoop down or crouch to access and rotate the adjustment member. It is of course trouble and time-consuming to do so.

### SUMMARY OF THE INVENTION

A primary object of the present invention is to provide a structurally improved kick pedal spring tension adjusting device, which includes an operating handle located above a kick pedal, allowing a user to turn the operating handle conveniently and quickly.

Another object of the present invention is to provide the above kick pedal spring tension adjusting device that includes a locating support provided with an elongated slot and a scale pattern, so that the spring tension has a size that is limited corresponding to a length of the elongated slot and can be directly read via the scale pattern.

A further object of the present invention is to provide the above kick pedal spring tension adjusting device that includes a quick release section. The kick pedal spring tension adjusting device can be quickly detached from the locating support simply by pulling the quick release section toward a footplate and then removing the quick release section from the locating support, so that the kick pedal spring tension adjusting device has the technical feature of being quickly connectable to and detachable from the locating support.

A still further object of the present invention is to provide the above kick pedal spring tension adjusting device that has an operating section configured as a wing nut having a T-shaped structure. The wing nut allows a user to quickly locate it and provides increased rotating lever arm to reduce the force needed by the user to turn the operating handle.

A still further object of the present invention is to provide the above kick pedal spring tension adjusting device that includes a hanging roller, which is rotatable along with a spring locating device to reduce the frictional wear produced when the kick pedal is kicked by the user.

To achieve the above and other objects, the kick pedal spring tension adjusting device according to the present invention is used with a drum set. The kick pedal spring tension adjusting device is connected to a foot pedal assembly and a beater to form a drum set kick pedal mechanism. The kick pedal spring tension adjusting device includes a locating support, an adjustment assembly, a spring assembly, and an operating handle. The locating support has a rotational shaft connected thereto and internally defines a receiving passage.

The foot pedal assembly including a footboard, a pivotal section, and a transmission member connected to between the footboard and the pivotal section. The beater includes a beater head and a beater shaft. The beater shaft has two opposite ends connected to the beater head and the pivotal section of the foot pedal assembly, respectively, such that the beater is swingable toward or far away from a drum top head of the drum set.

The adjustment assembly is movably provided on the locating support and includes a screw shaft located in the receiving passage and a spring locating section movably connected to the screw shaft. The spring locating section includes a displacement end invisibly located in the locating support and a connection end extended to an outer side of the locating support. The adjustment assembly further includes a stop pin connected to the spring locating section, and the locating support further includes an elongated slot communicable with the receiving passage; and the stop pin is movably located in the elongated slot, such that the spring tension is limited to a size correspondent with a length of the elongated slot.

The spring assembly having an end connected to the rotational shaft and another opposite end connected to the connection end of the spring locating section. The spring assembly includes a rotational shaft connecting section connected to the rotational shaft, a quick release section that is capable of being quickly connected to or detached from the connection end of the spring locating section, and a spring connected to between the rotational shaft connecting section and the quick release section. The rotational shaft connecting section includes a turnable member and a side-clamp turnable member connected to between the turnable member and the rotational shaft of the locating support; and the turnable member includes an opening for being hooked by a first end of the spring.

The connection end of the spring locating section includes a freely rotatable hanging roller, and the quick release section includes a fitting hole configured for correspondingly contacting with a turnable annular surface of the hanging roller. The quick release section includes a hole formed above the fitting hole for being hooked by a second end of the spring. The adjustment assembly includes a nut screwed onto the connection end of the spring locating section; when the quick release section is positioned on the hanging roller, the nut and the hanging roller are covered by the quick release section.

The operating handle includes a shank inserted into the receiving passage and an operating section located at an upper outer side of the locating support. The shank is connected to between the screw shaft of the adjustment assembly and the operating section; and the operating section is configured as a wing nut, the wing nut includes two grip heads expanding from two opposite ends of the wing nut, such that the wing nut and the shank together form a T-shaped structure.

When the operating handle is turned, the screw shaft is brought by the shank to rotate synchronously, such that the spring locating section moves along an axial direction of the screw shaft in a linear motion; and when the spring locating section moves linearly relative to the screw shaft, the spring assembly is changed from an original length to an adjusted length to adjust a spring tension of the spring assembly. And, the locating support further includes a scale pattern provided at one side of the elongated slot for correspondingly indicating the size of the spring tension.

The rotational shaft is located at an extended position from the axial direction, so that the rotational shaft is located perpendicular to the screw shaft; and the shank is inserted into the receiving passage along a shank direction that is oblique to the axial direction.

The present invention is featured by that the kick pedal spring tension adjusting device mainly includes the locating support, the adjustment assembly, the spring assembly, and the operating handle; and the kick pedal spring tension adjusting device is assembled to a foot pedal assembly and a beater to form a drum set kick pedal mechanism, such that the beater is swingable toward or far away from the drum top head of the drum set. The locating support is connected to a rotational shaft and internally defines a receiving passage; the adjustment assembly is movably provided on the locating support, and includes a screw shaft located in the receiving passage and a spring locating section movably connected to the screw shaft; the spring assembly has an end connected to the rotational shaft and another end to a connection end of the spring locating section; and the operating handle includes a shank inserted into the receiving passage and an operating section located at an upper outer side of the locating support, and the shank is connected to between the screw shaft and the operating section. The connection end of the spring locating section includes a freely rotatable hanging roller and the quick release section includes a fitting hole configured for correspondingly contacting with a turnable annular surface of the hanging roller. When the operating handle is turned, the screw shaft is brought by the shank to rotate synchronously, such that the spring locating section moves along an axial direction of the screw shaft in a linear motion; and when the spring locating section moves linearly relative to the screw shaft, the spring assembly is changed from an original length to an adjusted length to adjust a spring tension of the spring assembly. Meanwhile, the hanging roller rotates when the spring locating section moves, so that the frictional wear produced when the footboard is kicked by the user can be reduced. Further, the rotational shaft is located at an extended position from the axial direction, so that the rotational shaft is located perpendicular to the screw shaft; and the shank is inserted into the receiving passage along a shank direction that is oblique to the axial direction. Lastly, the quick release section of the spring assembly can be quickly connected to or detached from the connection end of the spring locating section, so that the user can easily remove the spring assembly from the spring locating device to facilitate storage of the footboard.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a perspective view showing a kick pedal spring tension adjusting device and a drum set kick pedal mechanism using the same according to a preferred embodiment of the present invention;

FIG. 2 is a perspective view of the kick pedal spring tension adjusting device according to the present invention;

FIG. 3 is a left side view of the kick pedal spring tension adjusting device of FIG. 2;

FIG. 4 is a right side view of the kick pedal spring tension adjusting device of FIG. 2;

FIG. 5 is a sectional side view of the kick pedal spring tension adjusting device of FIG. 2;

FIG. 6 is an exploded perspective view of the kick pedal spring tension adjusting device shown in FIG. 2;

FIG. 7 shows a spring locating section of the kick pedal spring tension adjusting device of the present invention is moved linearly to change an overall length of a spring assembly thereof; and

FIG. 8 shows a quick release section is located at a position away from the spring locating section.

### DETAILED DESCRIPTION OF THE PREFERRED EMBODIMENTS

The present invention will now be described with a preferred embodiment thereof and by referring to the accompanying drawings.

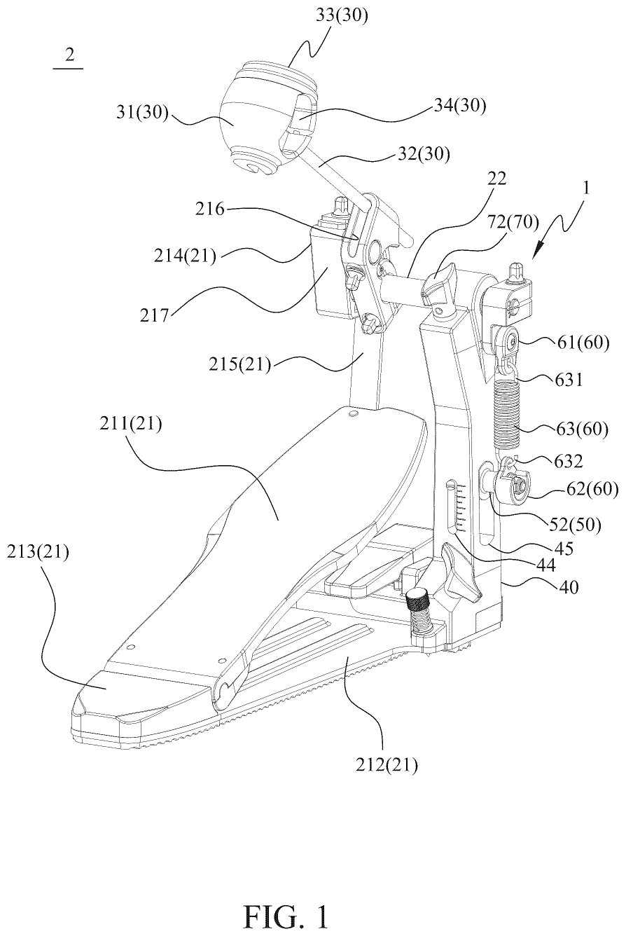

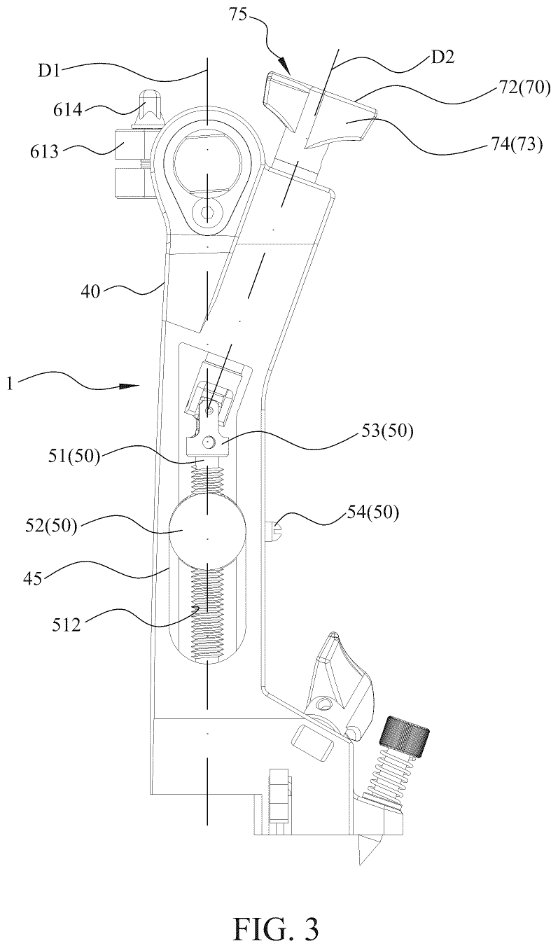

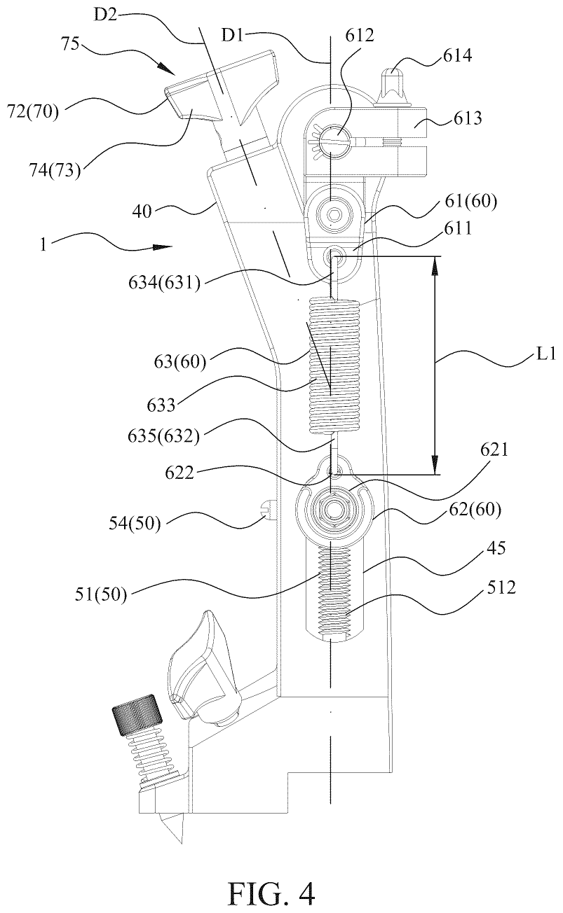

Please refer to FIGS. 1 to 4. A kick pedal spring tension adjusting device 1 according to the present invention is assembled to a drum set kick pedal mechanism 2. The kick pedal mechanism 2 further includes a foot pedal assembly 21, a rotational shaft 22, and a beater 30. The foot pedal assembly 21 consists of a footboard 211, a footplate 212, a heel plate 213, a pivotal section 214, and a transmission member 215 assembled to between the footboard 211 and the pivotal section 214. The heel plate 213 is connected to between the footboard 211 and the footplate 212, such that the footboard 211 is located above the footplate 212. The pivotal section 214 includes a through slot 216 and a rotational wheel 217 located at one side of the through slot 216. The beater 30 is inserted in the through slot 216, and the transmission member 215 is connected to between the rotational wheel 217 and the footboard 211. The transmission member 215 can be a chain or a belt, and there is not particular limitation to the material for forming the transmission member 215.

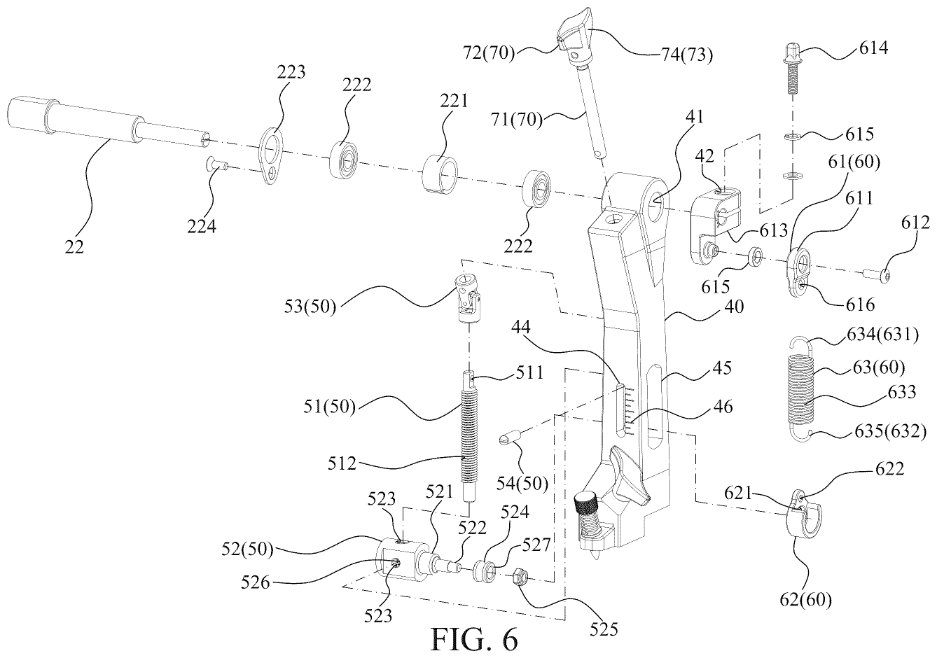

Please refer to FIGS. 1, 2, 3 and 6. The rotational shaft 22 includes a spacer 221, a plurality of bearings 222, a press plate 223, and a first screw 224. The beater 30 includes a beater head 31 and a beater shaft 32. The beater head 31 has a striking surface 33 for contacting and striking a drum top head of the drum set. The beater shaft 32 has an end inserted into the through slot 216 of the pivotal section 214 and another end inserted into a mounting space 34 provided on the beater head 31, such that the beater shaft 32 is connected at two opposite ends to the beater head 31 and the pivotal section 214 on the foot pedal assembly 21. When a user kicks the footboard 211, the footboard 211 is pivoted to move toward the footplate 212 and brings the transmission member 215 to move, so that the beater 30 connected to the pivotal section 214 is swung to move toward or away from the drum top head.

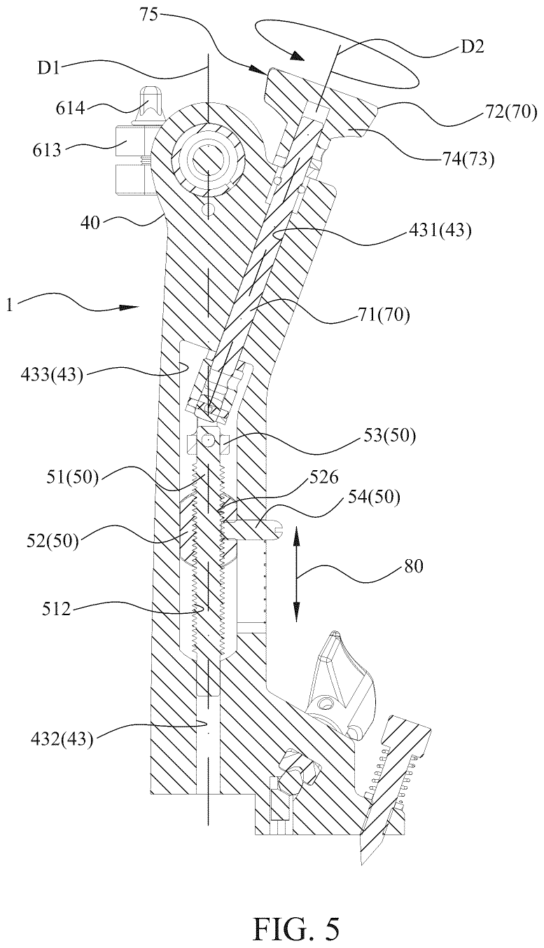

Please refer to FIGS. 1 to 6. The kick pedal spring tension adjusting device 1 includes a locating support 40, an adjustment assembly 50, a spring assembly 60, and an operating handle 70. The locating support 40 includes an insertion slot 41, a through bore 42 located in the vicinity of the insertion slot 41, a receiving passage 43, an elongated slot 44, an elongated through hole 45, and a scale pattern 46 provided to one side of the elongated slot 44. The insertion slot 41 and the through bore 42 are located at a top portion of the locating support 40, and the rotational shaft 22 is inserted into the insertion slot 41. The receiving passage 43 is formed in the locating support 40 and includes a first sliding section 431, a second sliding section 432, and a third sliding section 433 located between the first and the second sliding section 431, 432. The third sliding section 433 has a cross-sectional area larger than those of the first and the second sliding section 431, 432. Both the elongated slot 44 and the elongated through hole 45 are communicable with the receiving passage 43. The locating support 40 can be made of a suitable material without being particularly limited. For example, the locating support 40 can be made of an aluminum metal material.

Please refer to FIGS. 1 to 6. The adjustment assembly 50 is movably provided on the locating support 40. In the illustrated preferred embodiment, the adjustment assembly 50 includes a screw shaft 51, a spring locating section 52, a universal joint 53, and a stop pin 54. The screw shaft 51 is located in the second sliding section 432 of the receiving passage 43 and has a sunken hole 511 formed at an end thereof and a length of male thread 512 formed adjacent to the sunken hole 511. The spring locating section 52 is movably connected to another end of the screw shaft 51 and includes a displacement end 521 invisibly located in the locating support 40 and a connection end 522 connected to the displacement end 521. Both the spring locating section 52 and the universal joint 53 are received in the third sliding section 433 of the receiving passage 43. The displacement end 521 is provided with a plurality of round holes 523 for the screw shaft 51 and the stop pin 54 to insert thereinto, so that the stop pin 54 is connected to one side of the spring locating section 52 and the screw shaft 51 is located perpendicular to the stop pin 54 with the connection end 522 of the spring locating section 52 extended to an outer side of the locating support 40. The connection end 522 of the spring locating section 52 includes a freely turnable hanging roller 524 and a nut 525. Further, the spring locating section 52 is internally provided with a female thread 526 for meshing with the male thread 512 on the screw shaft 51.

Please refer to FIGS. 1 to 6. The spring assembly 60 includes a rotational shaft connecting section 61, a quick release section 62, and a spring 63. In the illustrated preferred embodiment, the rotational shaft connecting section 61 includes a turnable member 611, a second screw 612, a side-clamp turnable member 613, a square-head screw 614, and a plurality of washers 615. The second screw 612 is tightened to one side of the turnable member 611, and the first screw 224 is fastened to the press plate 223, so that the press plate 223, the bearings 222 and the spacer 221 all are fitted in the insertion slot 41 and the rotational shaft 22 is connected to the locating support 40. Meanwhile, the side-clamp turnable member 613 is held in place between the locating support 40 and the turnable member 611. The square-head screw 614 is screwed into the side-clamp turnable member 613 with the washers 615 being fitted between the square-head screw 614 and the side-clamp turnable member 613.

Please refer to FIGS. 1 to 6. The quick release section 62 includes a fitting hole 621, and a hole 622 formed above the fitting hole 621. The fitting hole 621 has an inner diameter larger than that of the hole 622 and is configured for correspondingly contacting with a turnable annular surface 527 of the hanging roller 524. Further, the fitting hole 621 has an outer contour larger than that of the turnable annular surface 527, so that the hanging roller 524 is rotatably confined in the fitting hole 621.

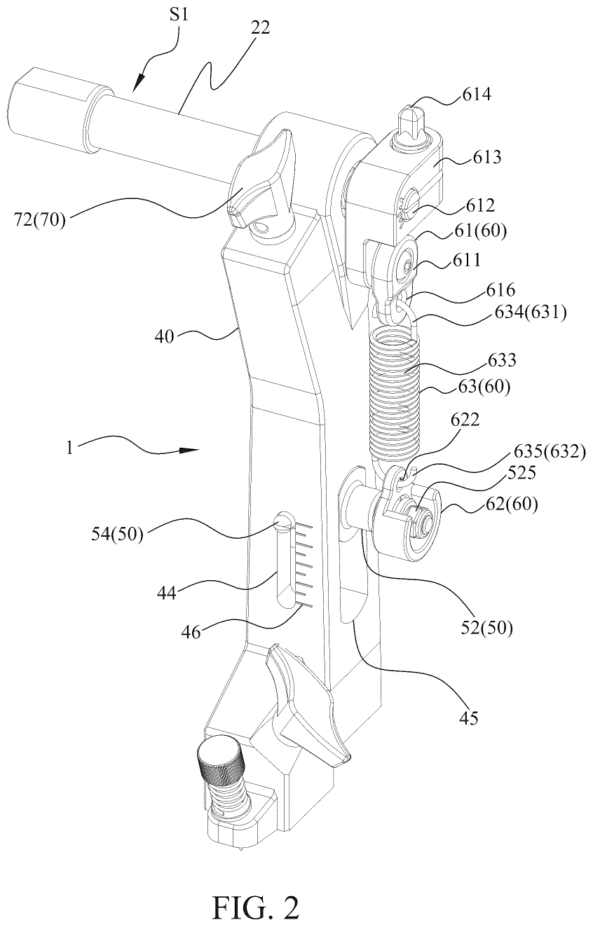

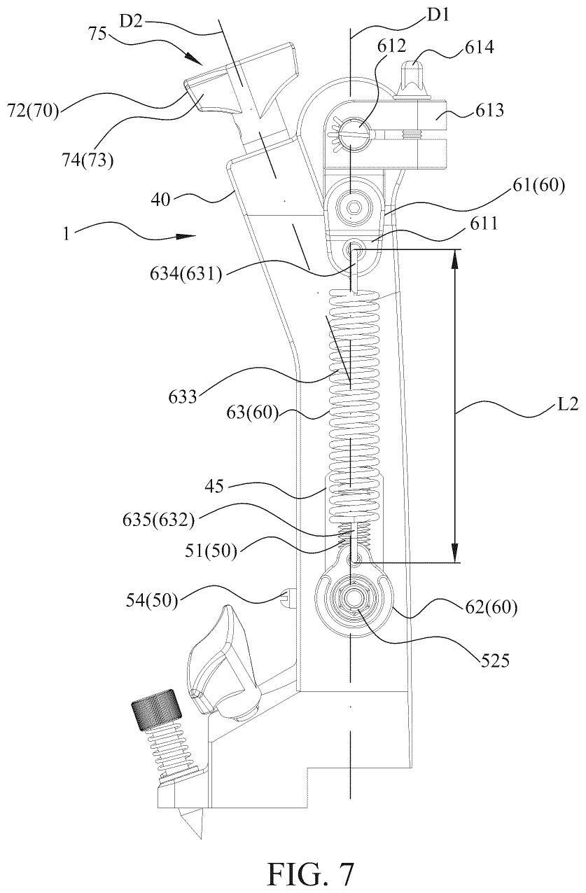

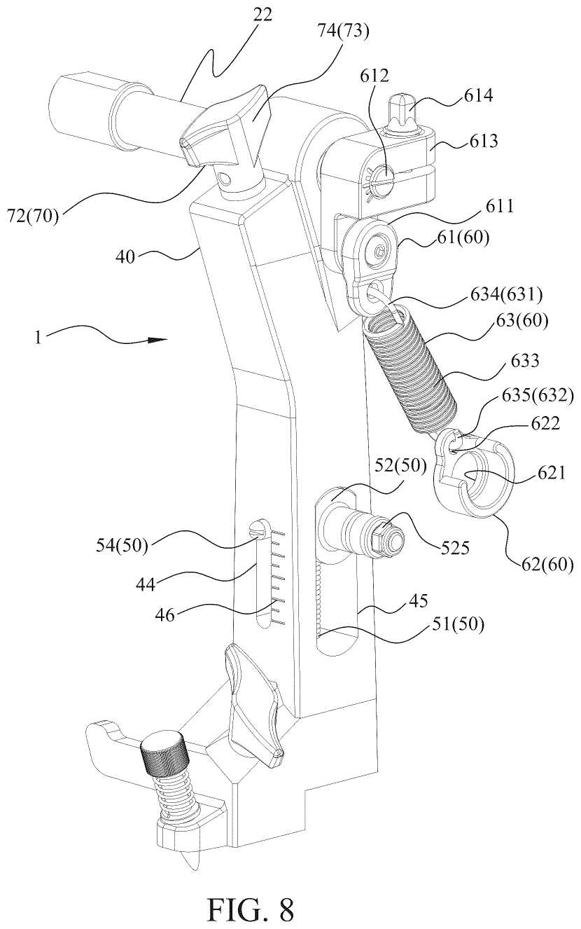

Please refer to FIGS. 2 to 8. In the illustrated preferred embodiment, the spring 63 has two opposite ends, namely, a first end 631 and a second end 632, and includes a deformable section 633 located between the first and the second end 631, 632. The first end 631 is formed into a first hook 634 and the second end 632 is formed into a second hook 635. The first hook 634 is hooked to an opening 616 on the turnable member 611 to thereby connect the spring 63 to the rotational shaft connecting section 61 and accordingly, connect the spring assembly 60 to the rotational shaft 22. The second hook 635 is hooked to the hole 622 on the quick release section 62 and the nut 525 of the adjustment assembly 50 is screwed onto the connection end 522 of the spring locating section 52; When the quick release section 62 is positioned on the hanging roller 524, the nut 525 and the hanging roller 524 are covered by the quick release section. Thus, the spring assembly 60 has one end connected to the rotational shaft 22 and another opposite end to the connection end 522 of the spring locating section 52.

Please refer to FIGS. 1 to 6. The operating handle 70 includes a shank 71 inserted into the receiving passage 43 and an operating section 72 projected from a top of the locating support 40. The shank 71 has a lower and an upper end connected to the universal joint 53 and the operating section 72, respectively, so that the shank 71 is connected to between the screw shaft 51 and the operating section 72. In the illustrated preferred embodiment, the operating section 72 is configured as a wing nut 73, which includes a grip head 74 gradually expanding from the spring assembly 60 toward the shank 71. That is, the grip head 74 and the shank together form a T-shaped structure 75. With the T-shaped structure 75, the wing nut 73 can be easily located by the user and also gives the operating section 72 an increased rotating lever arm to reduce the force needed to turn the operating handle 70.

Please refer to FIGS. 2 to 8. When the operating handle 70 is turned, the shank 71 will rotate in the first sliding section 431 of the receiving passage 43, and the universal joint 53 enables the shank 71 to bring the screw shaft 51 to rotate along with it synchronously. At this point, the spring locating section 52 moves along an axial direction D1 of the screw shaft 51 in a linear motion 80. Meanwhile, the hanging roller 524 and the quick release section 62 also move along the axial direction D1 in a linear motion 80, so that the spring 63 is also caused to move along the axial direction D1 in a linear motion 80. In this manner, the hanging roller 524 and the quick release section 62 can reduce a frictional force produced when the footboard 211 is kicked to turn pivotally. Further, when the spring locating section 52 moves relative to the screw shaft 51 in the linear motion 80, the spring assembly 60 is changed from an original length L1 to an adjusted length L2 to adjust a spring tension of the spring assembly 60. The scale pattern 46 provided at one side of the elongated slot 44 is corresponding to the spring tension and the stop pin 54 is movably disposed in the elongated slot 44 to limit the spring tension to a size corresponding to a length of the elongated slot 44. The user can quickly have an idea about the spring tension simply by comparing the location of the stop pin 54 in the elongated slot 44 and the scale pattern 46. And, since the rotational shaft 22 is located at an extended position S1 from the axial direction D1, the rotational shaft 22 is perpendicular to the screw shaft 51. Further, the shank 71 is extended into the first sliding section 431 of the receiving passage 43 along a shank direction D2, and the shank direction D2 is oblique to the axial direction D1.

Please refer to FIGS. 1, 3 and 8. When the user wants to store the drum set kick pedal mechanism 2, the spring assembly 60 must be detached from the locating support 40. To do this, the user needs only to pull the quick release section 62 toward the footplate 212 for the fitting hole 621 of the quick release section 62 to separate from the hanging roller 524 and then removes the second hook 635 of the spring 63 from the hole 622 of the quick release section 62. After the hole 622 of the quick release section 62 is separated from the second end 632 of the spring 63, the quick release section 62 can be quickly detached from the connection end 522 of the spring locating section 52.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A kick pedal spring tension adjusting device, comprising:
a locating support being connected to a rotational shaft and internally defining a receiving passage;
an adjustment assembly being movably provided on the locating support and including a screw shaft located in the receiving passage and a spring locating section movably connected to the screw shaft; the spring locating section including a displacement end invisibly located in the locating support and a connection end extended to an outer side of the locating support;
a spring assembly having an end connected to the rotational shaft and another opposite end connected to the connection end of the spring locating section; and
an operating handle including a shank inserted into the receiving passage and an operating section located at an upper outer side of the locating support; and the shank being connected to between the screw shaft of the adjustment assembly and the operating section; and
wherein when the operating handle is turned, the screw shaft is brought by the shank to rotate synchronously, such that the spring locating section moves along an axial direction of the screw shaft in a linear motion; and when the spring locating section moves linearly relative to the screw shaft, the spring assembly is changed from an original length to an adjusted length to adjust a spring tension of the spring assembly.

2. The kick pedal spring tension adjusting device as claimed in claim 1, wherein the rotational shaft is located at an extended position from the axial direction, so that the rotational shaft is located perpendicular to the screw shaft; and the shank is inserted into the receiving passage along a shank direction that is oblique to the axial direction.

3. The kick pedal spring tension adjusting device as claimed in claim 1, wherein the adjustment assembly further includes a stop pin connected to the spring locating section, and the locating support further includes an elongated slot communicating with the receiving passage; and the stop pin being movably disposed in the elongated slot, such that the spring tension is limited to a size correspondent with a length of the elongated slot.

4. The kick pedal spring tension adjusting device as claimed in claim 3, wherein the locating support further includes a scale pattern provided to one side of the elongated slot for correspondingly indicating the size of the spring tension.

5. The kick pedal spring tension adjusting device as claimed in claim 1, wherein the spring assembly includes a rotational shaft connecting section connected to the rotational shaft, a quick release section that is capable of being quickly connected to or detached from the connection end of the spring locating section, and a spring connected to between the rotational shaft connecting section and the quick release section.

6. The kick pedal spring tension adjusting device as claimed in claim 5, wherein the rotational shaft connecting section includes a turnable member and a side-clamp turnable member connected to between the turnable member and the rotational shaft of the locating support; and the turnable member including an opening for being hooked by a first end of the spring.

7. The kick pedal spring tension adjusting device as claimed in claim 5, wherein the connection end of the spring locating section includes a freely rotatable hanging roller, and the quick release section including a fitting hole configured for correspondingly contacting with a turnable annular surface of the hanging roller.

8. The kick pedal spring tension adjusting device as claimed in claim 7, wherein the quick release section includes a hole formed above the fitting hole for being hooked by a second end of the spring; and the adjustment assembly including a nut screwed onto the connection end of the spring locating section; when the quick release section is positioned on the hanging roller, the nut and the hanging roller are covered by the quick release section.

9. The kick pedal spring tension adjusting device as claimed in claim 1, wherein the operating section is configured as a wing nut, the wing nut includes two grip heads expanding from two opposite ends of the wing nut, such that the wing nut and the shank together form a T-shaped structure.

10. A drum set kick pedal mechanism, comprising:
a foot pedal assembly including a footboard, a pivotal section, and a transmission member connected to between the footboard and the pivotal section;
a beater including a beater head and a beater shaft; the beater shaft having two opposite ends connected to the beater head and the pivotal section of the foot pedal assembly, respectively, such that the beater is swingable toward or far away from a drum top head of the drum set; and
a spring tension adjusting device assembled to the pivotal section of the foot pedal assembly and including a locating support, an adjustment assembly, a spring assembly, and an operating handle; the locating support being connected to a rotational shaft and internally defining a receiving passage; the adjustment assembly being movably provided on the locating support and including a screw shaft located in the receiving passage and a spring locating section movably connected to the screw shaft, and the spring locating section including a displacement end invisibly located in the locating support and a connection end extended to an outer side of the locating support; the spring assembly having an end connected to the rotational shaft and another opposite end connected to the connection end of the spring locating section; and the operating handle including a shank inserted into the receiving passage and an operating section located at an upper outer side of the locating support, and the shank being connected to between the screw shaft of the adjustment assembly and the operating section; and
wherein when the operating handle is turned, the screw shaft is brought by the shank to rotate synchronously, such that the spring locating section moves along an axial direction of the screw shaft in a linear motion; and when the spring locating section moves linearly relative to the screw shaft, the spring assembly is changed from an original length to an adjusted length to adjust a spring tension of the spring assembly.
